(19) United States
(12) Patent Application Publication
(10) Pub. No.: US 2025/0141905 A1
(43) Pub. Date: May 1, 2025

(54) Automated Mapping and Analyzing of Service Account Chains in a Connected Computing System

(71) Applicant: Anetac, Inc., Los Altos, CA (US)

(72) Inventors: Yi Sun, San Jose, CA (US); Meng Xu, Los Altos, CA (US); Colin Ross, Spring Hill, FL (US); Baber Amin, Los Gatos, CA (US); Timothy Eades, Redwood City, CA (US)

(21) Appl. No.: 18/384,107

(22) Filed: Oct. 26, 2023

(51) Int. Cl. H04L 9/40

(52) U.S. Cl. CPC H04L 63/1433; H04L 63/102

(57) ABSTRACT

Automated mapping and analyzing of service account chains in a connected computing system are disclosed herein. An example method includes obtaining event data and context data related to service accounts of a network. normalizing and enriching the event data with the context data, storing the normalized and enriched data in a graph database and a time-series database, performing real-time risk analysis of the normalized and enriched data, the real-time risk analysis including analyzing account privileges for each of the service accounts, detecting one or more of the service accounts that do not comply with a least privilege rule and assessing a blast radius potential based on account access to various resources, a service connection link to a critical resource of the network, and/or a number of service account links and service accounts in a service chain, and identifying and remediating threats based on the risk analysis.

### CROSS-REFERENCE TO RELATED APPLICATIONS

N/A.

### FIELD

The present application relates to the automated mapping and analyzing of service account chains in a connected computing system, and more specifically, but not by way of limitation, to detecting and analyzing service accounts, including the creation of a graph of existing service accounts in a network and drawing a map correctly specifying and locating the connections between the various services accounts forming service chains. Apart from permitting real-time monitoring of the network, this mapping permits the network to perform real-time risk analysis based on the managed and unmanaged, directly and non-directly attached service accounts, precisely and accurately.

### SUMMARY

A system of one or more computers can be configured to perform particular operations or actions by virtue of having software, firmware, hardware, or a combination of them installed on the system that in operation causes or causes the system to perform the actions. One or more computer programs can be configured to perform particular operations or actions by virtue of including instructions that, when executed by a data processing apparatus, cause the apparatus to perform the actions. One general aspect includes a method for analyzing service accounts in a network. The method also includes obtaining event data and context data related to service accounts of a network. The method also includes normalizing and enriching the event data with the context data. The method also includes storing the normalized and enriched data in a graph database and a time-series database. The method also includes performing risk analysis of the normalized and enriched data, the real-time risk analysis may include: analyzing account privileges for each of the service accounts; detecting one or more of the service accounts that do not comply with a least privilege rule; and assessing a blast radius potential based on account access to various resources, a service connection link to a critical resource of the network, and/or a number of service account links and service accounts in a service chain; and constructing a graph of the service accounts based on the real-time risk analysis. Other embodiments of this aspect include corresponding computer systems, apparatus, and computer programs recorded on one or more computer storage devices, each configured to perform the actions of the methods. It will be understood that another method could use both real-time and historical information, such as detecting devations or behaviors that are different from past activity.

Implementations may include one or more of the following features. The method may include constructing a graph of the service accounts, including but not limited to, associated resources, applications, datastores, and processes, based on the normalized and enriched data, where the graph indicates interaction links between two or more accounts, resources, applications, datastores, and processes identifying service chains; The service accounts are non-person (not controlled by a human) accounts. The service account links represent authentication mechanisms between two or more of the resource, application, datastore, process accounts, the service account links including, but not limited to, tokens, usernames, passwords, and certificates. The method may include: ingesting data through cloud storage or a connector; and sending the ingested data through a processing pipeline for data aggregation, normalization, and enrichment. Performing real-time (and ongoing) risk analysis of the normalized and enriched data includes applying machine learning algorithms to the stored data to detect anomalous behaviors. The method may include: applying time-dependent statistical analysis to determine and/or predict patterns in the normalized and enriched data; scoring risk based (could be referred to as an impact score) on the determined patterns; and re-evaluating the risk score over a configurable time window. The threats identified are based on a combination of provisioned roles, privileges, access data including login and logoff events, and authentication methods—just to name a few (this list is not intended to be limiting and would include aspects that would be known to one of ordinary skill in the art). A service chain is identified uniquely for analysis based on a causal directionality between service accounts in the service chain. Implementations of the described techniques may include hardware, a method or process, or computer software on a computer-accessible medium.

One general aspect includes a method. The method also includes receiving event data and context data regarding resources in a network; identifying service accounts and service account links between one or more of the service accounts, and service chains using the event data and the context data; for each service chain, performing a risk analysis that identifies any of a toxic combination, a least privilege rule violation, and/or a blast radius potential; and generating an alert when the risk analysis identifies the toxic combination, the least privilege rule violation, and/or the blast radius potential. Other embodiments of this aspect include corresponding computer systems, apparatus, and computer programs recorded on one or more computer storage devices, each configured to perform the actions of the methods.

One general aspect includes a system for analyzing service accounts in a network. The system also includes a data retrieval module configured to obtain event data and context data related to service accounts of a network. The system also includes a data processing module configured to normalize and enrich the event data and the context data. The system also includes a graph database and a time-series database for storing the normalized and enriched data. The system also includes a risk analysis engine configured to perform a real-time risk analysis of the normalized and enriched data by analyzing account privileges for each of the service accounts, detecting one or more of the service accounts that do not comply with a least privilege rule, and assessing a blast radius potential based on account access to various resources, a service connection link to a critical resource of the network, and/or a number of service account links and service accounts in a service chain. The system also includes a threat detection module configured to identify and remediate threats based on the risk analysis. Other embodiments of this aspect include corresponding computer systems, apparatus, and computer programs recorded on one or more computer storage devices, each configured to perform the actions of the methods.

Implementations may include one or more of the following features. The system may include a graph construction module configured to construct a graph of the service accounts based on the normalized and enriched data, where the graph indicates service account links between two or more of the service accounts which also identify service chains. The service accounts are machine-to-machine accounts. Implementations of the described techniques may include hardware, a method or process, or computer software on a computer-accessible medium.

### BRIEF DESCRIPTION OF THE DRAWINGS

Exemplary embodiments are illustrated by way of example and not limited by the figures of the accompanying drawings, in which references indicate similar elements.

FIG. 1 is an example architectural environment where aspects of the present disclosure can be practiced.

FIG. 2 is a screenshot of a dashboard that displays service accounts and allows the user to rank service accounts based on risk or other parameters.

FIG. 3 is a screenshot of a user interface including the output of a risk assessment for a service chain and individual service accounts.

FIG. 4 is another screenshot of a user interface including the output of a risk assessment for multiple service chains and individual service accounts.

FIG. 5 is another screenshot of a user interface that shows the service links and service chain to which a high-risk service account belongs, and a blast radius calculation.

FIG. 6 is a flowchart of an example method of the present disclosure.

FIG. 7 is a flowchart of another example method of the present disclosure.

FIG. 8 is a diagrammatic representation of an example machine in the form of a computer system that can be used to implement aspects of the present technology.

### DETAILED DESCRIPTION OF EXAMPLE EMBODIMENTS

### Overview

In modern networking environments, the dynamic and complex nature of service accounts necessitates a precise methodology for identification, analysis, and management. The present disclosure provides an advanced framework for detecting and analyzing service accounts within a network. Advantageously, the systems and methods have the capacity to formulate a comprehensive graph of all service accounts, ensuring that each resource is accurately represented in relation to other resources in the system to which it is connected. Users can control a system of the present disclosure to generate a comprehensive graph and receive alerts, just as examples.

One advantage disclosed herein includes adeptness in delineating the specific interconnections between various service accounts, which gives rise to what can be described as “service links” and “service chains”. These links and chains, once elucidated, serve as a resource in understanding the intricate web of dependencies and interactions that characterize the network's operational landscape.

Beyond the mere representation of service accounts and their interrelations, the present disclosure offers additional capabilities. Firstly, it facilitates real-time monitoring of the entire network. By continuously overseeing the state and behavior of service accounts and their respective links and chains, a system as disclosed herein can swiftly detect anomalies, thereby ensuring uninterrupted and optimal network performance.

Another advantage is equipping the network with the ability to conduct real-time risk analysis. Leveraging the detailed map of service accounts and their links and chains, the system can pinpoint potential vulnerabilities, both in directly attached service accounts and those that are non-directly linked. Once a threat or vulnerability is identified, the system identifies or remediates measures.

This not only ensures that threats are neutralized promptly but also that the network's integrity and functionality are preserved. The present disclosure augments network management capabilities by providing a granular view of service accounts, enabling proactive threat detection based on accurate and up-to-date information.

### Example Embodiments

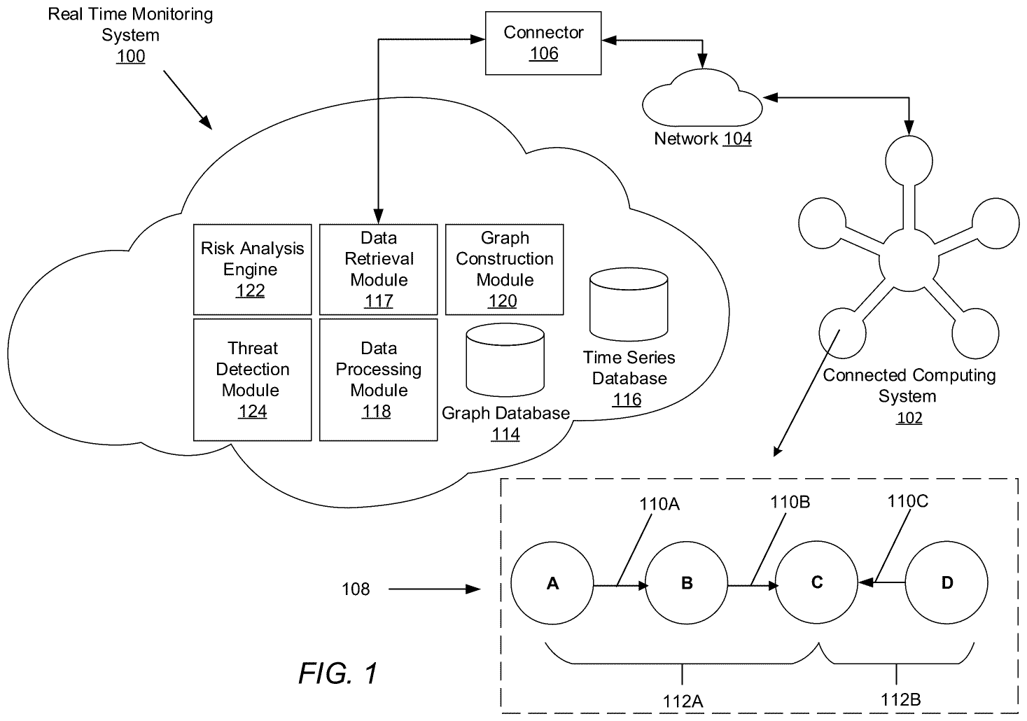

FIG. 1 is an example architectural environment where aspects of the present disclosure can be practiced. The environment can include a real time monitoring system “system 100” that can provide automated mapping and analyzing of service account chains in a connected computing system 102. These components can be coupled to one another over a network 104 (or can be located on the same physical or virtual resouce) that can include any public and/or private wired and/or wireless network that would be known to one of ordinary skill in the art.

The connected computing system 102 can include any computing system such as a server, which can be a virtual server or physical server. The connected computing system 102 could also be a collection of virtual or physical computing systems such as a container, a cloud, or other connected structures.

The connected computing system 102 includes a plurality of resources. A resource is to be construed broadly as any network element such as an application, a computer, a container, a thread, a software-as-a-service feature, a firewall, a gateway, or any network element that would be known to one of ordinary skill in the art.

It will be understood that each resource in the connected computing system 102 may be connected to other resources and the system 100 will map relationships between them. Service accounts are machine-to-machine (non-human) accounts that are automated processes. In some embodiments, the service accounts may often have higher privileges than other network elements. Because the service accounts often end up in code as cleartext and because they are embedded as code, it makes it very hard to rotate credentials. Thus, it is hard to know where an individual service account is used, how often it is used, what the scope of its usage is, and other parameters. The system can be used to collect data regarding service accounts, map the same, detect threats, and remediate the same.

Connections between resources using service accounts are referred to as service account links. In some instances, the directionality of the service account links can be identified. When a plurality of service accounts are connected by service account links and they have the same directionality, they can be identified as a service chain.

An example service chain is shown in FIG. 1, where resource A and resource B are connected via service account link 110A. Also, resource B is connected to resource C via service account link 110B. Because the service account links 110A and 110B have the same directionality they form a service chain 112A. In contrast, resource C is connected to resource D via service account link 110C. However, the directionality of service account link 110C is different, therefore another service chain 112B is identified. While the service chains illustrated are linear, some service chains may not be linear in nature and can have more complex graphical relationships, including circular dependencies. It will be understood that a link is indicative of an established relationship between machines, such as authentication, token exchange, handshake, username and password exchange, certificate-based authorization, and the like. These are merely examples of negotiated relationships between machines and are not intended to be limited.

In some instances, the system 100 can execute the data retrieval module 117 to collect data from the connected computing system 102 using a connector 106, which can act as a virtualized agent that can exist in the system 100. In another example, the connector 106 can be deployed in an on-premises solution that is local to the connected computing system 102. The administrator of the connected computing system 102 could also directly upload information to the system 100 with or without the use of a connector.

In some instances, the connected computing system 102 could use a solution that collects big data from the connected computing system 102. These data include event logs that are indicative of the connected computing system 102. Regardless of how data are gathered, the data can include event data, inventory data, and context data pertaining to elements within the connected computing system 102. In one embodiment, the inventory data can include data obtained from IT infrastructure data such as device management, user data, domains, and objects within a connected computing system 102, directory access protocols, or any other datasets that provide contextual information (e.g., behaviors, performance, roles, privileges, and so forth). Contextual data would be things which cannot be logically understood, for example, the name of the person who is responsible for that particular resource or service account, which business application that service account is tied to, or what regulation that resource/service account must comply with.

Once event and context data are obtained, the system 100 can execute the data processing module 118 to normalize and enrich the event data with the context and inventory data. The context data can be used to enrich basic log data (event data) pertaining to the service accounts, service account links, and service chains (connected computing system data). Once the data are normalized and enriched, the data can be stored in two different databases. One database is a graph database 114 and the other is a time-series database 116. The graph database 114 includes data pertaining to the connected computing system data that can be used to generate the graphs disclosed herein that map the connected computing system 102. Data can also be stored in the time-series database 116 to create data that can be parsed and displayed according to time. In some instances, a user-configurable time window can be used to view data at a specific point in time or over a defined interval of time. As will be disclosed herein, risk scores for the connected computing system, service accounts, and/or service chains can be calculated and viewed through a configurable time window.

The risk analysis engine 122 can be executed to perform various types of risk analyses such as toxic combination analysis, least privilege rules, and blast radius potential-just to name a few. In general, the risk analysis engine 122 may employ machine learning, artificial intelligence, neural networks, or the like to perform correlation analyses, detect threats, and infer anomalous behaviors.

One example would be a toxic combination analysis that could include the risk analysis engine 122 detecting that a service account has multiple privileges provisioned to it that creates a risk situation. This can include any combination of privileges that pose a danger. An example would be a service account having backup administration privilege but also write privileges in a role to a particular database. This combination is determined by the risk analysis engine 122 to pose a threat.

In another example, the risk analysis engine 122 can determine that a service account does not have the least amount of privileges assigned that are needed by the service account. For example, this could occur when a service account has been accidentally provisioned a level of access or a role that is not needed for the tasks performed by the service account. The risk analysis engine 122 could examine what actions the service account is actually performing and compare the privileges assigned. The risk analysis engine 122 could determine that the service account has been over-privileged and flag the same as a risk.

It will be understood from this example, that the risk analysis engine 122 can perform analyses of event and context data for service accounts, service account links, and service chains using real-time data obtained from the connected computing system 102. That is, the risk analysis engine 122 can make determinations of risk, anomalous behaviors, threat detection, and the like without relying on pre-determined rulesets. Stated otherwise, the risk analysis engine 122 can use statistical analysis and correlation analysis to review the data from the connected computing system 102 over time and make inferences or other determinations of risk/threat.

The risk analysis engine 122 can be configured to determine multiple events correlated together in order to infer or identify a service chain (all related and directed causal) to a critical resource), forming a possible attack path, this is a reportable anomaly

In general, the data can be collected over a period of time and can be associated with time stamps. Because data are collected over time, time is a dimension that impacts learning. That is, the risk analysis engine 122 can determine events before, after, and around an event of interest. This temporality can allow the risk analysis engine 122 to deduce privileges de novo, from the data alone without specific or a priori knowledge of the privileges.

The risk analysis engine 122 can determine behaviors such as the age of the service account, how many other service accounts are connected, the directionality of the service account links, if the service account is in compliance with certain cybersecurity policies (or other network policies), if not in compliance, how long the service account has been out of compliance, and other parameters/behaviors of interest.

As noted above, one example type of analysis can include a toxic combination analysis. A “toxic combination” refers to a configuration or set of conditions within the realm of service account management that poses an elevated risk to the security and integrity of a network or system. These combinations often arise from the intersection of service account privileges and actual usage patterns, which, when misaligned, can inadvertently grant malicious actors an opportunity to exploit the network.

A toxic combination is the situation where a service account has been provisioned with two or more privileges that pose a security risk related to database access and storage and administration—example, a toxic combination of permissions could allow someone to indirectly escalate privileges of an account to administrator, allowing that account now to create new accounts also with admin privileges. This not only exposes the databases to potential misuse but also makes it a tempting target for attackers who can exploit the account's credentials.

In essence, identifying and mitigating toxic combinations involves an understanding of the privileges provisioned to service accounts, continuous monitoring of their actual usage, and a proactive approach to refining their access based on real-time data and analysis.

Another type of analysis includes a “least privilege” rule. The principle of “least privilege” advocates that any system, user, or process should be granted only the minimal privileges required to perform its designated function. By limiting access rights, the potential damage from errors or malicious attacks is curtailed, making the system more secure and easier to manage.

One example includes a service account created specifically for a web application to access a database. The principle of least privilege would dictate that this account should only have access to specific tables or procedures it needs, rather than the entire database. If the web application only requires read access to a certain table, then the service account should not have write or delete permissions for that table or any other unrelated tables.

In another example, service accounts used for backups should have read access to the files and directories they back up, but they don't necessarily need write access to those same files on the primary system. If the backup service account were given write access and it was compromised, malicious changes could be made to the original data.

In yet another example, if an application uses a service account to communicate with an API, that account should only have the necessary permissions to make specific API calls. If the application only requires data retrieval (GET requests), then the service account shouldn't have permission to modify (POST, PUT, DELETE) data through the API.

Another example type of analysis performed by the risk analysis engine 122 includes a blast radius potential. The term “blast radius” refers to the scope of potential damage or exposure from a security incident, often stemming from misconfigured or abused privileges. In the domain of service accounts, the blast radius becomes especially concerning due to the automated and often high-level access these accounts possess.

One example would include a centralized identity provider service account. Many organizations use centralized identity providers like Active Directory or LDAP. A service account with elevated permissions in such systems, if compromised, could allow unauthorized modifications of user privileges, potentially giving attackers the keys to the kingdom. The blast radius here is vast, affecting every system and user that relies on the centralized identity provider. So, if a service account is in a service chain that sits within this paradigm, that service account should be identified and graphed as such.

Another example includes a cloud infrastructure management account. In a cloud environment, service accounts are often used for automation and orchestration tasks. A service account with broad permissions across multiple cloud services can, if misused, lead to widespread data breaches, unauthorized resource provisioning, or data destruction. The potential damage spans the entirety of the cloud environment and any connected systems or services.

Yet another example includes monitoring and logging service accounts. Service accounts used for monitoring systems often have read access to multiple critical systems to fetch performance metrics or logs. If compromised, an attacker could glean valuable information about the entire infrastructure, leading to targeted attacks. Moreover, if the service account can also write or modify logs, attackers can conceal their activities.

In response to the above, the risk analysis engine 122 and threat detection module could be executed to detect risk/threats and generate data that can be used to generate graphs or alerts. The utilization of AI, especially in the context of service accounts, offers an approach to proactively identify vulnerabilities and minimize potential threats. By analyzing event logs and contextual data sources such as LDAP and Active Directory, AI can provide an intricate risk assessment, balancing considerations of toxic combinations, the principle of least privilege, and blast radius potential.

Event logs continuously document service account activities, recording every instance of access, modification, and interaction. By combining this with contextual data from sources like Active Directory, an AI system can recognize patterns indicative of malicious behavior. For example, if a service account embedded in code frequently authenticates using clear-text credentials, AI can flag this as a toxic combination, especially if the account possesses high privileges.

By comparing the actual operations, a service account conducts (as recorded in event logs) against its designated roles and permissions (sourced from LDAP or Active Directory), AI can ascertain if the account operates beyond its necessary remit. Accounts accessing resources or performing actions outside their expected behavior indicate a violation of the principle of least privilege. AI can then assign higher risk scores to such accounts, suggesting a reevaluation of their permissions.

Understanding the interconnectedness of service accounts and the resources they access is critical for determining the potential fallout from a security breach. The AI used by the risk analysis engine 122, can examine the network of interactions from event logs and the hierarchical structures from context sources and can construct a model of dependencies. Should a service account with extensive connections (indicative of a larger blast radius) show anomalous behavior, the AI would assign a significantly higher risk score, reflecting the widespread damage a compromise could inflict.

By cross-referencing real-time operational data (event logs) with structural context (LDAP, Active Directory), the risk analysis engine 122 can dynamically generate risk scores for service accounts. These scores take into account the complexities of toxic combinations, least privilege adherence, and potential blast radius (or other metrics), providing a holistic measure of the security stature of each service account. Such proactive AI-driven assessments enable organizations to preemptively address vulnerabilities, reinforcing their cybersecurity infrastructure.

The risk analysis engine 122 can consider aspects of time, because, as noted above, the enriched data can be stored in the time series database 116. Integrating data into a time series database introduces the element of temporality into the risk assessment process. This kind of database specializes in handling data points indexed in time order, enabling the nuanced analysis of events as they unfold over designated periods. By evaluating service account activities and behaviors within specific time windows, the risk analysis engine 122 can capture the dynamic and evolving nature of the service accounts, thereby providing a more rounded view of potential vulnerabilities and risks.

For instance, by selecting a specific time window, the risk analysis engine 122 can scrutinize events that might appear benign or inconsequential in isolation but, when viewed collectively over a period, reveal patterns indicative of slow-burning attacks or creeping privileges escalation. This ability to understand and analyze service account behavior over time, rather than just in snapshots, is paramount in capturing more stealthy, advanced threats.

However, given the complex interplay of events, system configurations, and external factors, it is conceivable that an initial analysis may yield inconclusive or borderline risk scores. In such scenarios, the time series database enables the risk analysis engine 122 to have the flexibility to rerun analyses, adjust parameters or incorporate additional data, ensuring that determinations are robust and reliable.

Furthermore, the sequential nature of time series data ensures that each analytical layer can feed into subsequent ones. The stratified nature of risk assessment, wherein toxic combinations feed into the principle of least privilege, which in turn influences the assessment of blast radius potential, presents a robust framework for service account evaluation. Each layer, while distinct, informs and enriches the subsequent layer. When integrated with a time series database, this layered approach becomes dynamic, adapting to the ever-evolving cybersecurity landscape.

Over time, as service accounts' behaviors and privileges change, what once was deemed a benign combination might escalate into a potential violation of least privilege principles. Similarly, an account's initially limited blast radius could expand due to the accrual of new access rights or integrations over time. By continuously monitoring these layered metrics within the temporal context, organizations can ensure that their risk assessments remain accurate, relevant, and reflective of both immediate and emerging threats. This interconnected, time-sensitive methodology underscores the importance of iterative analyses and the ever-evolving nature of cybersecurity risk.

It's also essential to recognize that as systems evolve, threat landscapes shift, and operational behaviors change, the same data analyzed at different points in time might yield distinct results. A service account's risk score today, based on recent activity, might differ significantly when re-evaluated a month later with additional data. This temporal fluidity underscores the need for continuous monitoring and periodic reassessment to stay abreast of an ever-changing cybersecurity environment.

In summary, the incorporation of data into a time series database enhances the dynamism and depth of service account risk assessment. By adding the temporal dimension, users can achieve a richer, more layered understanding of their security postures, enabling proactive measures and agile responses.

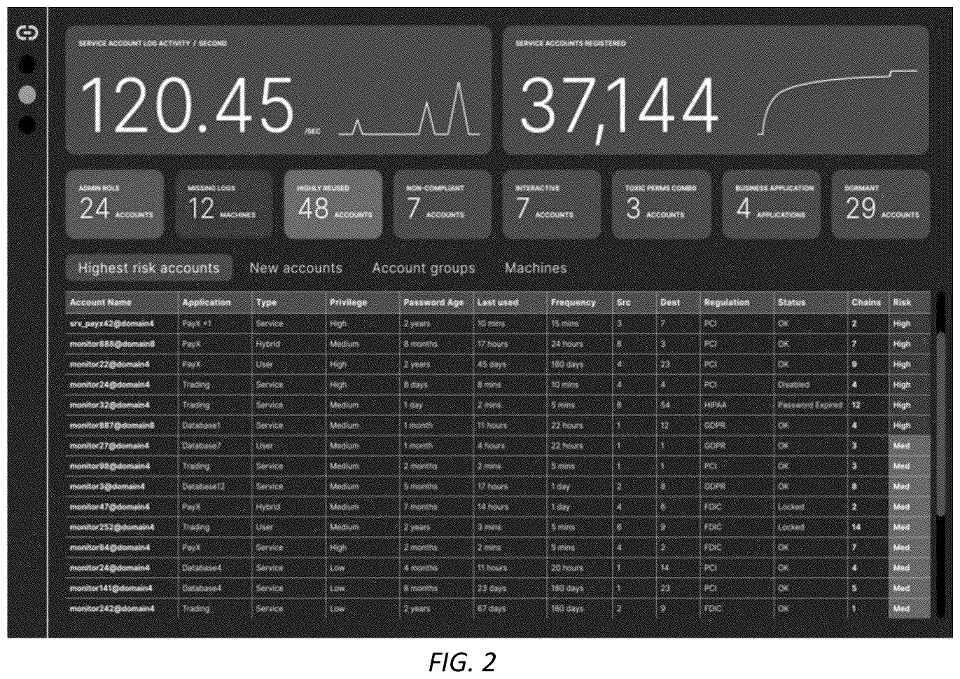

FIGS. 2-5 illustrate screenshots of dashboards or user interfaces where service accounts, service account links, and service chains can be displayed. In FIG. 2, the service account log activity and the number of service accounts registered are shown. A number of service accounts with administrator roles, missing logs, highly reused, non-compliant (with any policy), interactive, toxic permissions, business applications, and dormant are shown in aggregate. A user can sort service accounts with the highest risk scores, new accounts, account groups (service chains), and individual machines. Attributes for each service account can be displayed in a table with information such as account name, application, type, privileges, password application, last used, frequency, source/destination (indicative of a service account link), regulation, status, chains (number of service links or chains to which the service account belongs), as well as a risks score.

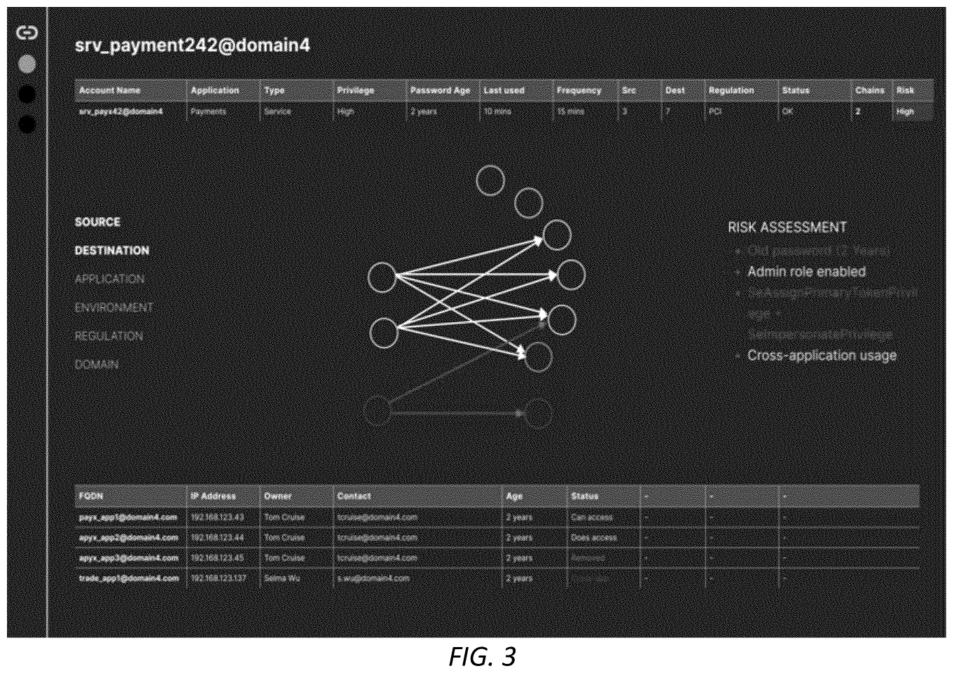

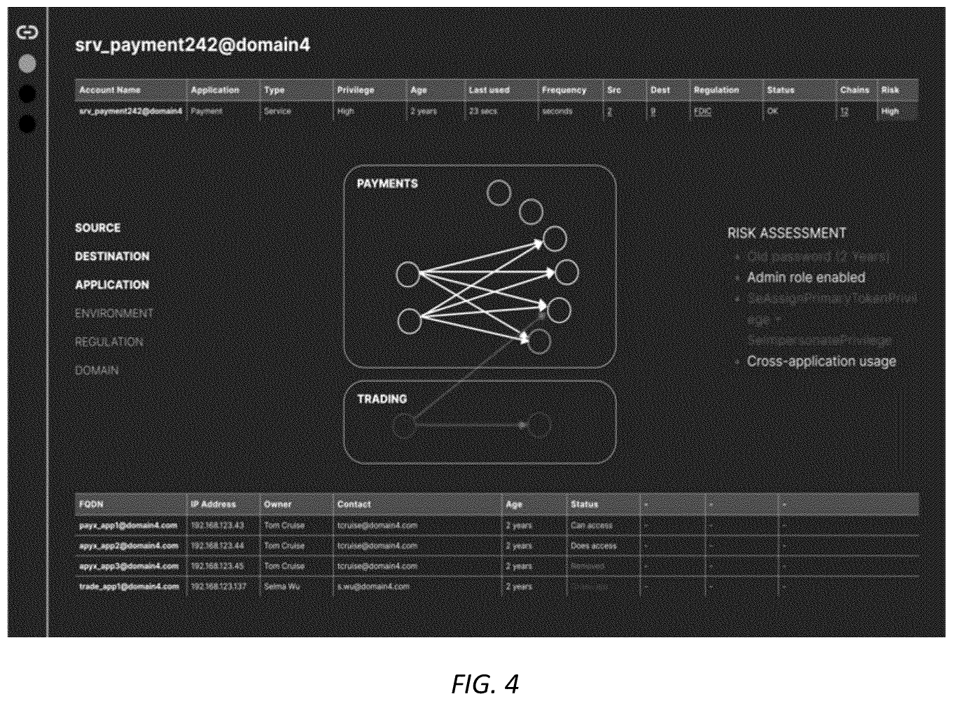

FIG. 3 shows service accounts, their service account links, and therefore the service chains to which they belong. The service account links are shown with arrows and a detailed risk assessment is shown that identifies high-risk data such as an old password, and two risky privileges that have been assigned. Moderate (yellow) risk may identify that the service account has cross-application usage and an admin role enabled. In this example, the graph construction module 120 (see FIG. 1) has been executed to draw a graph that represents the service accounts and service links which are shown in FIG. 3. Again, this information has been obtained from the graph database 114. This UI can also show a source, a destination, an application, an environment, a regulation(s), and a domain for a service account. In FIG. 4, the same graph is shown but each application such as payments and trading has been denoted, with certain service accounts falling into each application.

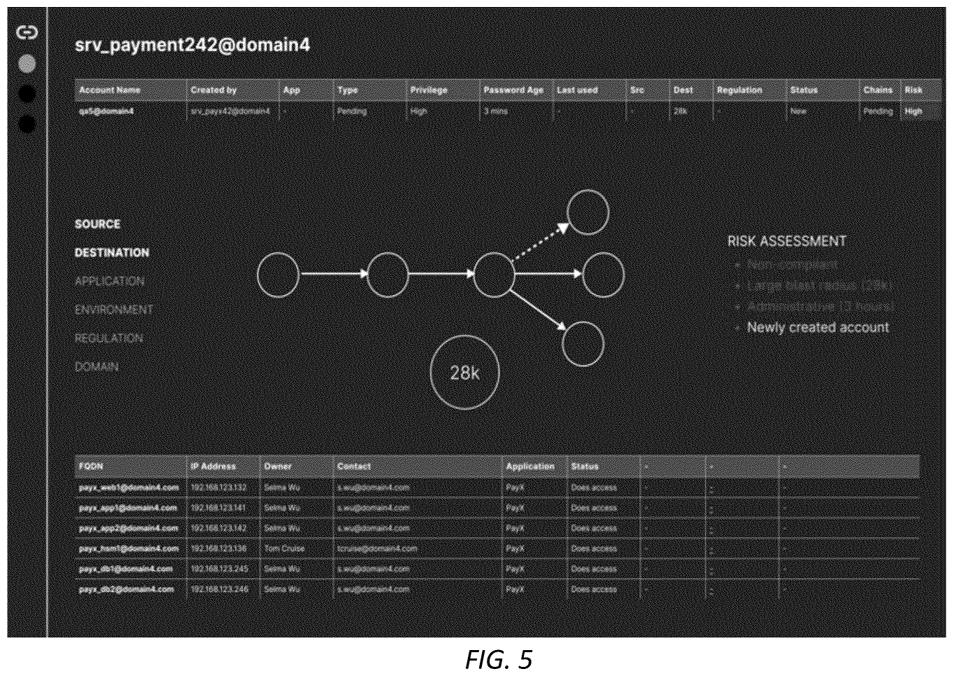

FIG. 5 is another UI showing service account details. In this UI, a graph of service accounts that are connected to a resource in question is shown. A risk assessment is shown that indicates that the service account is non-compliant, has a large blast radius, has administrative privileges, and is a newly created account. In this example, the service account has a blast radius potential to reach 28,000 additional resource.

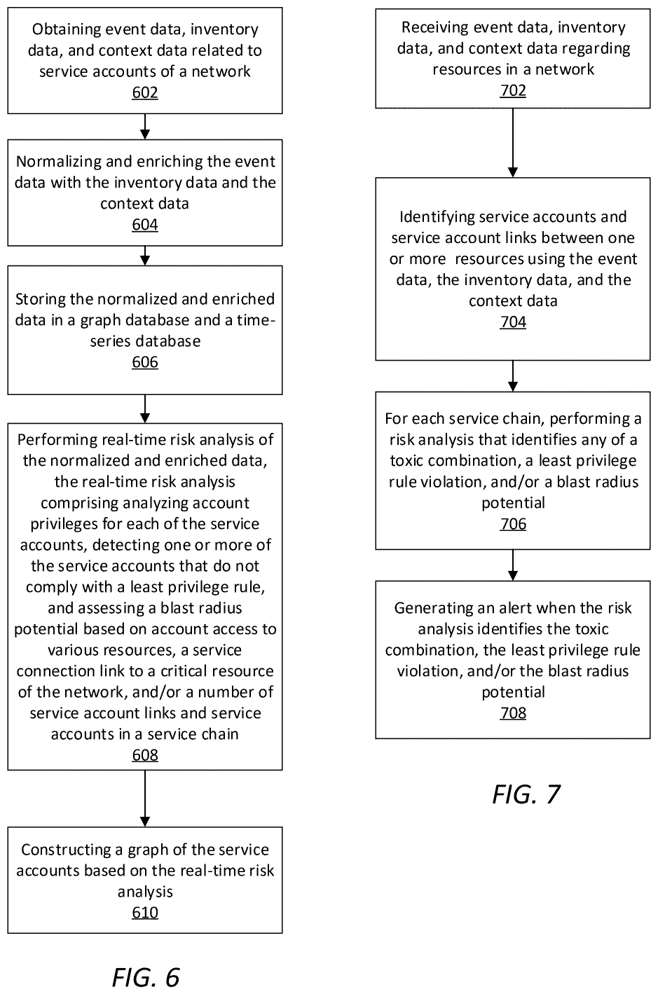

FIG. 6 is a flowchart of an example method that includes a step 602 obtaining event data and context data related to service accounts of a network. The method initiates with the process of obtaining event data, inventory data, and context data, specifically focusing on the service accounts within a network.

Next, the method includes a step 604 of normalizing and enriching the event data with the inventory data and the context data. Following data acquisition, the method advances to normalizing the event data. This process involves integrating or enhancing the event data using the previously acquired context data to provide a richer dataset.

In another step 606, the method includes storing the normalized and enriched data in a graph database and a time-series database. Post-normalization and enrichment, the method dictates the storage of this newly refined data into two specific types of databases: a graph database and a time-series database. These databases facilitate different functionalities necessary for subsequent steps.

The method includes a step 608 of performing real-time risk analysis of the normalized and enriched data, the real-time risk analysis comprising analyzing account privileges for each of the service accounts, detecting one or more of the service accounts that do not comply with a least privilege rule, and assessing a blast radius potential based on account access to various resources, a service connection link to a critical resource of the network, and/or a number of service account links and service accounts in a service chain.

The performance of real-time risk analysis on the stored data is comprehensive, encompassing the examination of account privileges for every service account. Within this process, the method identifies service accounts that breach the ‘least privilege’ rule. Furthermore, an assessment is carried out to determine the ‘blast radius potential’. This assessment hinges on various factors, including the service account's access to diverse resources, the presence of a service connection link to any critical network resource, and the count of service account links and service accounts forming a service chain.

The method can conclude with a step 610 of graphing threats based on the risk analysis. That is, based on the insights derived from the risk analysis, the method proceeds to create graphical representations or maps of the potential threats. This visualization aids in better comprehension and subsequent mitigation strategies. Examples of visualizations are shown in FIGS. 2-5.

FIG. 7 is a flowchart of an example method of the present disclosure. The method includes a step 702 of receiving event data and context data regarding resources in a network.

The next step 704 includes identifying service accounts and service account links between one or more of the resources, and service chains, using the event data and the context data. In some instances, a service chain is identified uniquely for analysis based on a causal directionality between service accounts in the service chain.

Next, the method includes a step 706 where for each service chain, performing a risk analysis that identifies any of a toxic combination, a least privilege rule violation, and/or a blast radius potential. Finally, the method includes a step 708 of generating an alert when the risk analysis identifies the toxic combination, the least privilege rule violation, and/or the blast radius potential.

Alerts can be delivered through a multitude of mechanisms, optimized to ensure prompt attention from the appropriate personnel. On a centralized management platform or a Security Information and Event Management (SIEM) system frequently accessed by network administrators or IT teams, notifications can appear directly on the dashboard. These notifications, often color-coded based on severity, provide a visual representation of the network's health. In tandem with this, automated emails containing detailed alert information, recommended actions, and links for deeper investigation can be dispatched to predefined recipients, ensuring that key personnel, whether they are IT administrators, network teams, or security response units, are promptly informed.

For situations demanding immediate attention, especially outside of regular working hours, an SMS can be sent to the mobile phones of designated team members. This method offers the advantage of cutting through the digital noise, ensuring that the alert isn't overlooked. Simultaneously, organizations that have embraced collaboration platforms like Slack or Microsoft Teams can integrate alerts directly into these platforms. By creating a dedicated channel for such notifications, real-time collaboration on incident response becomes seamless, fostering a proactive response environment. Moreover, for those organizations employing centralized logging solutions, forwarding alerts as syslog messages offers a method for their aggregation, correlation, and further comprehensive analysis.

In some instances, the method could include applying time-dependent statistical analysis to determine patterns in the normalized and enriched data, scoring risk based on the determined patterns and re-evaluating the risk score over a configurable time window.

In more detail, the concept of applying time-dependent statistical analysis revolves around examining data sequences to discern patterns that evolve or emerge over specific periods. By employing such an approach on normalized and enriched data, one can obtain insights that might be obscured when considering data points in isolation. For instance, the risk analysis module 122 might identify a pattern where a service account, which typically accesses a database during standard business hours, begins to show irregular access times, such as late nights or early mornings, over a span of several weeks. This shift in behavior can be indicative of potential misuse or a compromised account.

Once these patterns are determined, the risk scoring system 122 generates calculates a potential threat level based on the observed patterns. Using the earlier example, the risk scoring system 122 might assign a moderate risk score to the service account showing irregular access times. However, if combined with other suspicious behaviors, such as increased data downloads during these odd hours, the risk score might escalate.

The dynamic nature of networks and user behaviors demands periodic re-evaluations of risk scores. By configuring a specific time window, organizations can adjust the frequency of these assessments based on their security needs and data volume. For example, a financial institution might opt for a daily re-evaluation during end-of-month processing when transaction volumes are high. However, a manufacturing firm with steady data patterns might opt for weekly or even monthly evaluations. This periodic reassessment ensures that the risk scores remain current and reflective of the evolving state of the system, accommodating for changing patterns and emerging threats.

Another example method for performing this analysis could include segmenting the normalized and enriched data into specific time intervals, applying a time-dependent statistical analysis to each segmented interval to detect evolving patterns or irregularities specific to the service accounts behaviors within the network, computing a dynamic risk score based on the detected patterns, where the dynamic risk score represents the potential threat level associated with the observed behaviors, and periodically updating the dynamic risk score, based on configurable time window settings, to reflect current network behaviors and adapt to emerging threats or changes in established patterns.

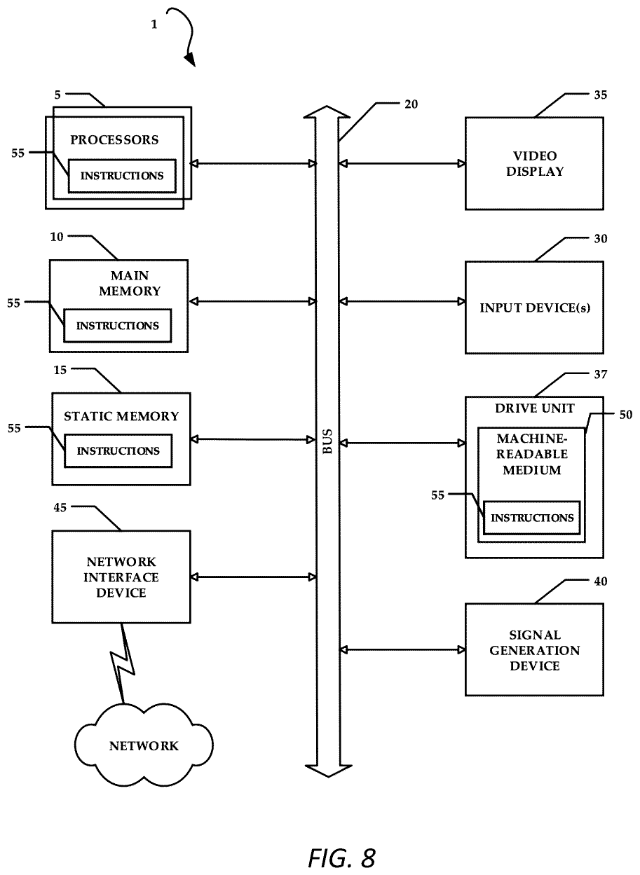

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A method for analyzing service accounts in a network, the method comprising:
obtaining event data, inventory data, and context data related to service accounts of a network;
normalizing and enriching the event data with the inventory data, and the context data;
storing the normalized and enriched data in a graph database and a time-series database;
performing real-time risk analysis of the normalized and enriched data, the real-time risk analysis comprising:
analyzing account privileges for each of the service accounts;
detecting one or more of the service accounts that do not comply with a least privilege rule; and
assessing a blast radius potential based on account access to various resources, a service connection link to a critical resource of the network, and/or a number of service account links and service accounts in a service chain; and
constructing a graph of the service accounts based on the real-time risk analysis.

2. The method according to claim 1, wherein the graph indicates service account links between two or more of the resources which also identify service chains.

3. The method of claim 1, wherein the service accounts are machine-to-machine accounts.

4. The method of claim 1, wherein the service account links represent authentication mechanisms between two or more of the service accounts, the service account links including, but not limited to, tokens, usernames, passwords, and certificates.

5. The method of claim 1, further comprising:
ingesting data through cloud storage or a connector; and
sending the ingested data through a processing pipeline for data aggregation, normalization, and enrichment.

6. The method of claim 1, wherein performing real-time risk analysis of the normalized and enriched data includes applying machine learning algorithms to the normalized and enriched data to detect anomalous behaviors.

7. The method of claim 1, further comprising:
applying time-dependent statistical analysis to determine patterns in the normalized and enriched data;
scoring risk based on the determined patterns; and
re-evaluating the risk score over a configurable time window.

8. The method of claim 1, wherein threats identified are based on a combination of provisioned roles, privileges, access data including login and logoff events, and authentication methods.

9. The method of claim 1, further comprising:
segmenting the normalized and enriched data into specific time intervals;
applying a time-dependent statistical analysis to each of the specific time intervals to detect evolving patterns or irregularities specific to behaviors of the service accounts;
computing a dynamic risk score based on the detected patterns, wherein the dynamic risk score represents a potential threat level associated with the behaviors; and
periodically updating the dynamic risk score based on configurable time window settings, to ensure the dynamic risk score remains relevant to current network behaviors.

10. A method, comprising:
receiving event data and context data regarding resources in a network;
identifying service accounts and service account links between one or more resources and service chains using the event data and the context data;
for each service chain, performing a risk analysis that identifies any of a toxic combination, a least privilege rule violation, and/or a blast radius potential; and
generating an alert when the risk analysis identifies the toxic combination, the least privilege rule violation, and/or the blast radius potential.

11. The method of claim 1, wherein a service chain is identified uniquely for analysis based on a causal directionality between service accounts in the service chain.

12. A system for analyzing service accounts in a network, comprising:
a data retrieval module configured to obtain event data, inventory data, and context data related to service accounts of a network;
a data processing module configured to normalize and enrich the event data with the inventory data and the context data;
a graph database and a time-series database for storing the normalized and enriched data;
a risk analysis engine configured to perform real-time risk analysis of the normalized and enriched data by analyzing account privileges for each of the service accounts, detecting one or more of the service accounts that do not comply with a least privilege rule, and assessing a blast radius potential based on account access to various resources, a service connection link to a critical resource of the network, and/or a number of service account links and service accounts in a service chain; and
a threat detection module configured to identify and remediate threats based on the risk analysis.

13. The system according to claim 12, further comprising a graph construction module configured to construct a graph of the service accounts based on the normalized and enriched data, wherein the graph indicates service account links between two or more of the resources which also identify service chains.

14. The system of claim 12, wherein the service accounts are machine-to-machine accounts.

15. The system of claim 12, wherein the service account links represent authenticated service account access between two or more of the resources, the service account links including, but not limited to, tokens, usernames, passwords, and certificates.

16. The system of claim 12, further comprising a data ingestion module configured to ingest data through cloud storage or a connector configured to send the ingested data through for data aggregation, normalization, and enrichment.

17. The system of claim 12, wherein the risk analysis engine is further configured to apply machine learning algorithms to the stored data to detect anomalous behaviors.

18. The system of claim 12, wherein the risk analysis engine is configured with artificial intelligence statistical analysis that applies a time-dependent statistical analysis to determine patterns, generate a risk score based on the determined patterns, and re-evaluate the risk score over configurable time windows.

19. The system of claim 12, wherein the threats identified are based on a combination of provisioned roles, privileges, access data including login and logoff events, and authentication methods.
